(19) United States
(12) Patent Application Publication
(10) Pub. No.: US 2020/0011229 A1
(43) Pub. Date: Jan. 9, 2020

(54) DRIVEN TURBOCHARGER WITH DUAL STAGE COMPRESSORS

(71) Applicant: SuperTurbo Technologies, Inc., Loveland, CO (US)

(72) Inventors: Tom Waldron, Loveland, CO (US); Ryan Sherrill, Loveland, CO (US); Jared W. Brin, Loveland, CO (US)

(73) Assignee: SuperTurbo Technologies, Inc., Loveland, CO (US)

(21) Appl. No.: 16/503,099

(22) Filed: Jul. 3, 2019

Related U.S. Application Data
(60) Provisional application No. 62/694,078, filed on Jul. 5, 2018.

(51) Int. Cl. F02B 37/013; F02B 37/04

(52) U.S. Cl. CPC F02B 37/013; F02B 37/04

(57) ABSTRACT

Disclosed is a driven turbocharger for an engine with dual stage compressors. In addition to the turbine and compressor on the main turbo shaft of the driven turbocharger, an additional compressor is coupled to a transfer gear of the driven turbocharger to provide two-stage compression for the engine. This enables higher boost pressures, which can help boost engine efficiency. The driven turbocharger retains the single turbine, so that no additional heat sinks are added to the exhaust to keep exhaust temperatures high for aftertreatment functionality.

### BACKGROUND

Driven turbochargers (super-turbochargers) are powered by more than just the exhaust gas turbine, which provides for additional operating modes through supercharging.

### SUMMARY

An embodiment of the present invention may therefore comprise a driven turbocharger for an engine comprising: a first compressor connected to a turbo shaft; a turbine connected to the turbo shaft; a speed reduction drive coupled to the turbo shaft that has a low speed output coupled to a transfer gear; a transmission coupled to the transfer gear that transfers power between the engine and the driven turbocharger; a second compressor coupled to the transfer gear, wherein the second compressor and the first compressor are arranged in series to provide boosted airflow to the engine.

An embodiment of the present invention may therefore further comprise a method of providing boosted airflow to an engine with a driven turbocharger comprising: connecting a first compressor to a turbo shaft of the driven turbocharger; connecting a turbine to the turbo shaft of the driven turbocharger; coupling a speed reduction drive to the turbo shaft that has a low speed output coupled to a transfer gear; coupling a transmission to the transfer gear that transfers power between the engine and the driven turbocharger; coupling a second compressor to the transfer gear, wherein the second compressor and the first compressor are arranged in series to provide the boosted airflow to the engine.

### BRIEF DESCRIPTION OF THE DRAWINGS

FIG. 1 is an isometric view of a driven turbocharger for an internal combustion engine.

FIG. 2 is a schematic of a mechanically driven turbocharger for an engine with an additional compressor.

FIG. 3 is a schematic of an electrically driven turbocharger for an engine with an additional compressor.

FIG. 4 is a schematic of a driven turbocharger for an engine with an additional compressor coupled to a transfer gear through a clutch.

FIG. 5 is a schematic of a driven turbocharger for an engine with an additional compressor coupled to a single gear that meshes with a transfer gear.

### DETAILED DESCRIPTION OF THE EMBODIMENTS

The operation of a driven turbocharger may be found in U.S. Pat. No. 8,561,403, issued Oct. 22, 2013, entitled “Super-Turbocharger Having a High Speed Traction Drive and a Continuously Variable Transmission,” U.S. Pat. No. 8,668,614, issued Mar. 11, 2014, entitled “High Torque Traction Drive,” U.S. Pat. No. 8,608,609, issued Dec. 17, 2013, entitled “Symmetrical Traction Drive,” U.S. Pat. No. 9,670,832, issued Jun. 6, 2017, entitled “Thrust Absorbing Planetary Traction Drive SuperTurbo,” and U.S. Pat. No. 9,581,078, issued Feb. 28, 2017, entitled “Super-Turbocharger Having a High Speed Traction Drive and a Continuously Variable Transmission.” U.S. Pat. Nos. 8,561,403, 8,668,614, 8,608,609, 9,670,832, and 9,581,078 are specifically incorporated herein by reference for all that they disclose and teach.

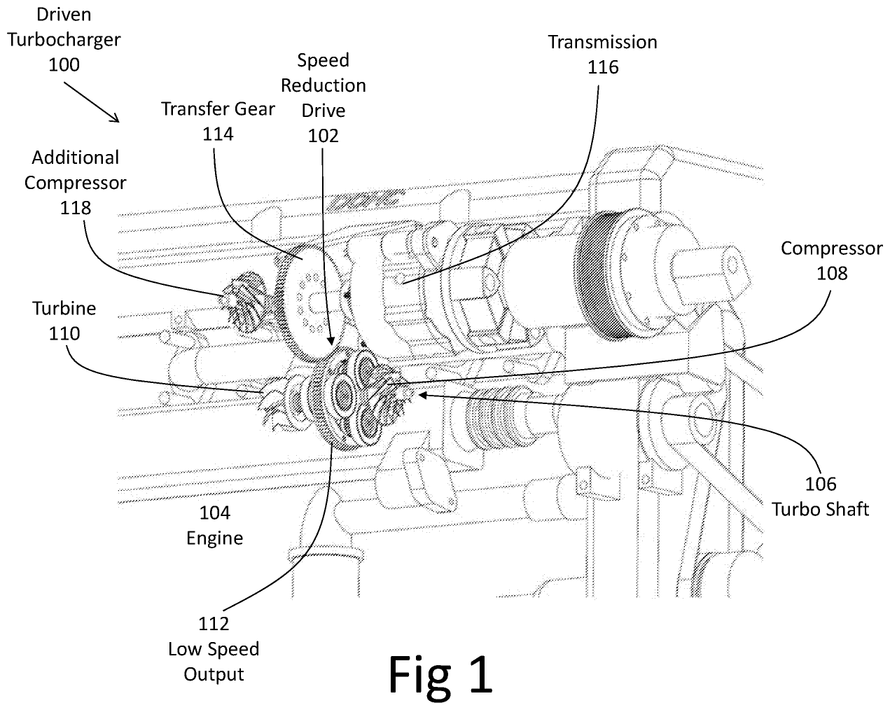

One type of driven turbocharger uses a speed reduction drive coupled to the turbo shaft to connect to lower speed devices. FIG. 1 is an isometric view of a driven turbocharger 100 for an internal combustion engine 104. Driven turbocharger 100 may be coupled to engine 104 mechanically or electrically, and various configurations of each are possible. Driven turbocharger 100 uses a speed reduction drive 102 that is coupled to turbo shaft 106. Compressor 108 and turbine 110 are connected to turbo shaft 106. Speed reduction drive 102 is a traction drive as shown, but any other type of speed reducing drive may be used. Speed reduction drive 102 has a low speed output 112 that is coupled to a transfer gear 114. Transmission 116 is coupled to transfer gear 114 and transfers power between engine 104 and driven turbocharger 100. Transmission 116 may be a CVT (continuously variable transmission) that is mechanically coupled to engine 104 as shown. Transmission 116 may also be an electric motor/generator that is electrically coupled to engine 104. Additional compressor 118 is coupled to transfer gear 114. Additional compressor 118 and compressor 108 are arranged in series to provide boosted airflow to engine 104. Additional compressor 118 may be a radial compressor as shown, or may be an axial or positive displacement compressor as well. Driven turbocharger 100 retains a single turbine 110, so that thermal management of exhaust aftertreatment downstream of turbine 110 is not negatively impacted, and thermal management strategies such as those discussed in U.S. patent application Ser. No. 16/109,581, filed Aug. 22, 2018, entitled “Turbine Bypass for Engine with Driven Turbocharger” may be utilized. U.S. patent application Ser. No. 16/109,581 is specifically incorporated herein by reference for all that it discloses and teaches.

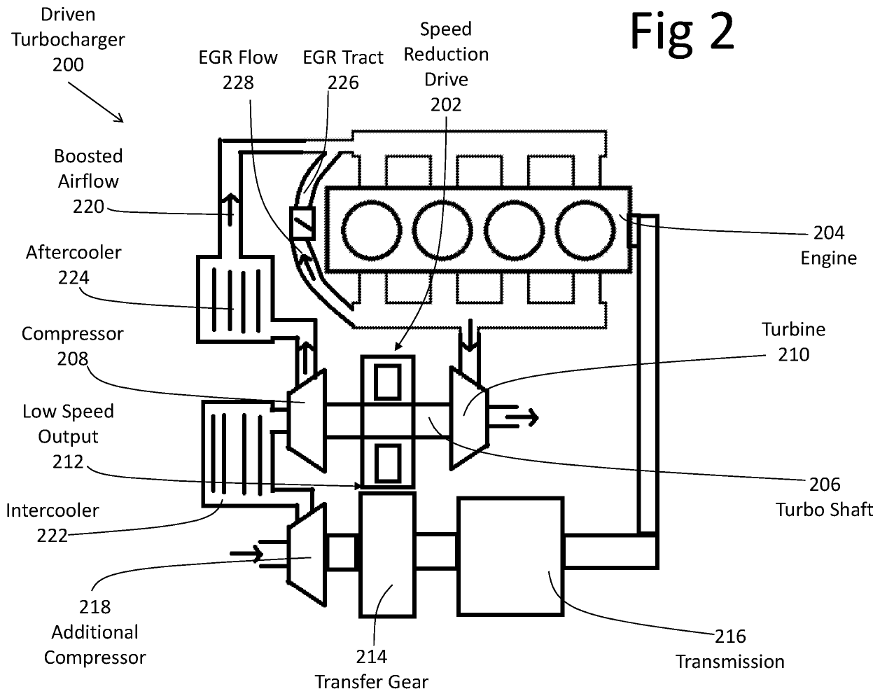

FIG. 2 is a schematic of a mechanically driven turbocharger 200 for an engine 204 with an additional compressor 218. Compressor 208 is connected to turbo shaft 206. Turbine 210 is connected to turbo shaft 206. Speed reduction drive 202 is coupled to turbo shaft 206 and has a low speed output 212 that is coupled to transfer gear 214. Transmission 216 is coupled to transfer gear 214 and transfers power between engine 204 and driven turbocharger 200. Transmission 216 may be a CVT mechanically coupled to engine 204. Additional compressor 218 is coupled to transfer gear 214, and additional compressor 218 and compressor 208 are arranged in series to provide boosted airflow 220 to engine 204. Additional compressor 218 and compressor 208 may be arranged as the first compressor. Also shown is an intercooler 222 located between additional compressor 218 and compressor 208, as well as an aftercooler 224 after compressor 208 to cool the boosted airflow 220 to reduce compression work on boosted airflow 220. Optionally, an EGR (exhaust gas recirculation) tract 226 may be provided for EGR flow 228 to engine 204. EGR tract 226 is shown as providing EGR flow 228 from an inlet of turbine 210 to an inlet of engine 204. Other configurations may be used as well. As shown, additional compressor 218 is a radial compressor, but other compressor types may be used.

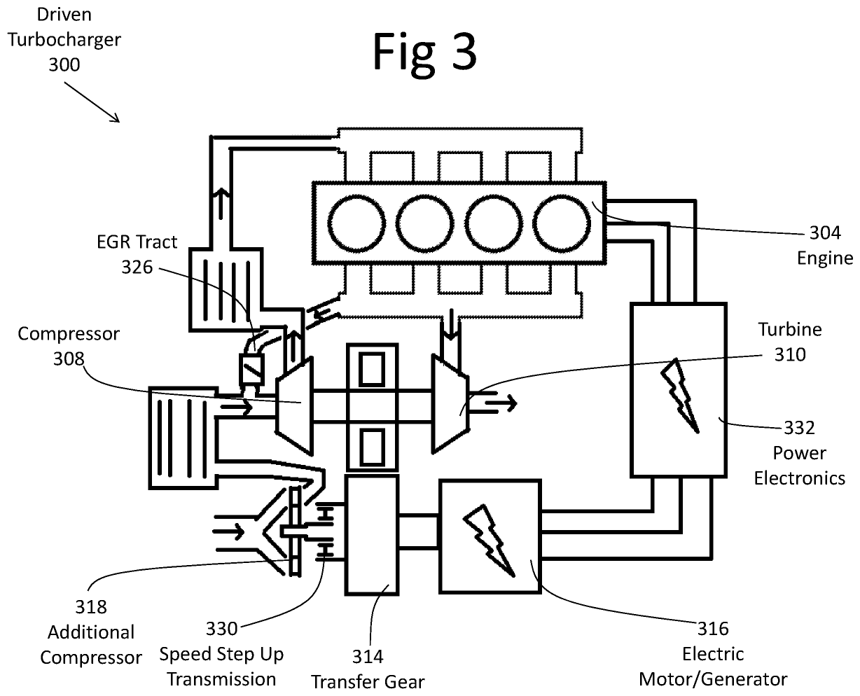

FIG. 3 is a schematic of an electrically driven turbocharger 300 for an engine 304 with an additional compressor 318. As shown, additional compressor 318 is an axial compressor. Also shown is a speed step up transmission 330 between transfer gear 314 and additional compressor 318. Speed step up transmission 330 increases the rotational speed from transfer gear 314 to additional compressor 318 if additional compressor 318 requires higher speeds than provided by transfer gear 314. Speed step up transmission 330 may comprise a traction drive transmission. Speed step up transmission 330 may also comprise a gear drive transmission. The necessary ratio and speed capacity of speed step up transmission 330 to provide the required speed of additional compressor 318 will determine its design. Transmission 116 from FIG. 1 is an electric motor/generator 316 electrically coupled to engine 304 through power electronics 332. Power is transferred electrically between engine 304 and driven turbocharger 300 through power electronics 332. An alternative EGR tract 326 is also shown. Exhaust gas recirculation is provided through EGR tract 326 from an inlet of turbine 310 to an inlet of compressor 308. This path of EGR flow may be utilized if a sufficient pressure gradient to flow EGR does not exist between an inlet of turbine 310 and an inlet of engine 304 as illustrated in FIG. 2.

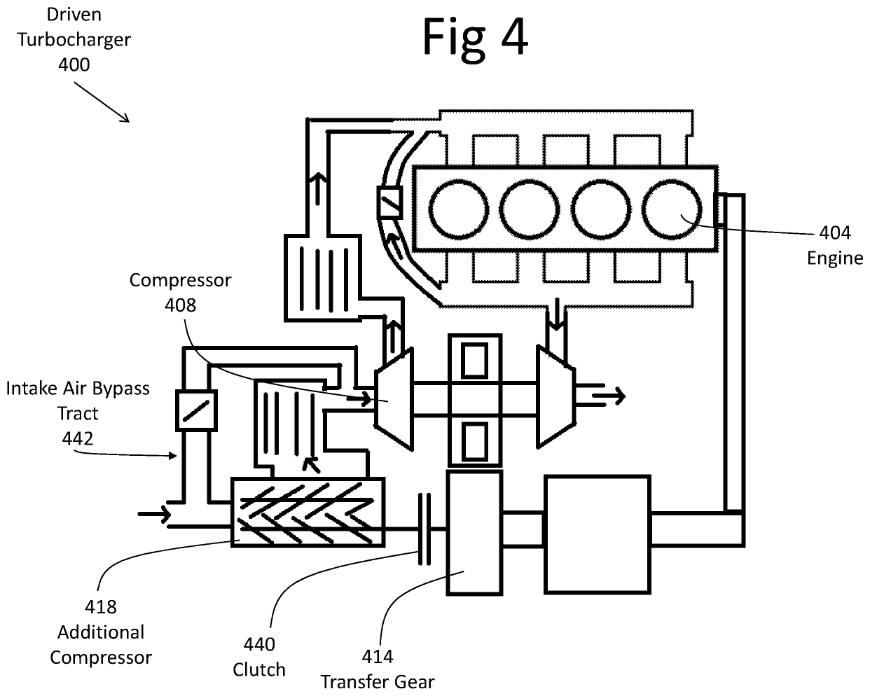

FIG. 4 is a schematic of a driven turbocharger 400 for an engine 404 with an additional compressor 418 coupled to a transfer gear 414 through a clutch 440. As shown, additional compressor 418 is a positive displacement compressor. Clutch 440 is located between transfer gear 414 and additional compressor 418 so that additional compressor 418 may be disconnected from transfer gear 414 when additional boost from additional compressor 418 is not needed for engine 404. Also shown is an intake air bypass tract 442 around additional compressor 418 that supplies intake air directly to compressor 408. Intake air bypass tract 442 may be provided to allow airflow to go around additional compressor 418 when it is disconnected and flow directly to compressor 408 of driven turbocharger 400.

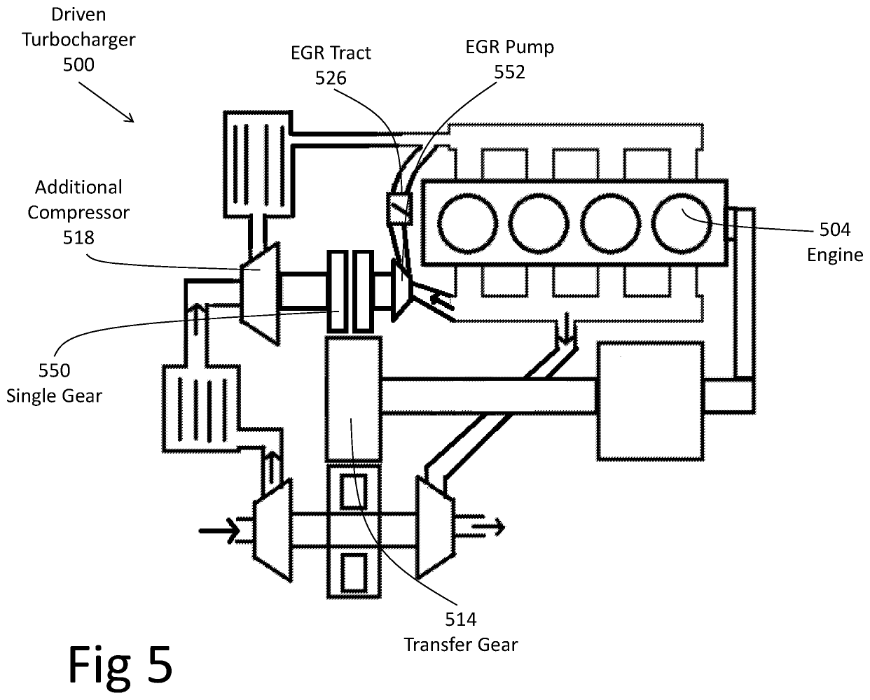

FIG. 5 is a schematic of a driven turbocharger 500 for an engine 504 with an additional compressor 518 coupled to a single gear 550 that meshes with a transfer gear 514. Single gear 550 provides a simple way to couple additional compressor 518 to transfer gear 514, while providing a gear ratio between transfer gear 514 and additional compressor 518 to allow additional compressor 518 to rotate at a different speed than transfer gear 514. Single gear 550 also allows for moving the axis of rotation of additional compressor 518 away from the axis of rotation of transfer gear 514, which can provide more space for additional compressor 518 and make packaging of driven turbocharger 500 onto engine 504 easier. Also shown is an EGR pump 552 that is coupled to transfer gear 514. EGR pump 552 may be used to drive EGR flow when a negative pressure gradient is present in EGR tract 526. The coupling of both additional compressor 518 and EGR pump 552 to transfer gear 514 demonstrates the ability to mesh a variety of different gears to transfer gear 514 to drive different devices.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A driven turbocharger for an engine comprising:
a first compressor connected to a turbo shaft;
a turbine connected to said turbo shaft;
a speed reduction drive coupled to said turbo shaft that has a low speed output coupled to a transfer gear;
a transmission coupled to said transfer gear that transfers power between said engine and said driven turbocharger;
a second compressor coupled to said transfer gear, wherein said second compressor and said first compressor are arranged in series to provide a boosted airflow to said engine.

2. The driven turbocharger of claim 1 wherein said second compressor is an axial compressor.

3. The driven turbocharger of claim 1 wherein said second compressor is a radial compressor.

4. The driven turbocharger of claim 1 wherein said second compressor is a positive displacement compressor.

5. The driven turbocharger of claim 1 further comprising:
a clutch located between said transfer gear and said second compressor.

6. The driven turbocharger of claim 1 further comprising:
a speed step up transmission between said transfer gear and said second compressor.

7. The driven turbocharger of claim 6 wherein said speed step up transmission comprises a traction drive transmission.

8. The driven turbocharger of claim 6 wherein said speed step up transmission comprises a gear drive transmission.

9. The driven turbocharger of claim 1 wherein said additional compressor is coupled to a single gear that meshes with said transfer gear.

10. The driven turbocharger of claim 1 further comprising:
an intercooler located between said second compressor and said first compressor.

11. The driven turbocharger of claim 1 further comprising:
an EGR (exhaust gas recirculation) tract from an inlet of said turbine to an inlet of said first compressor.

12. The driven turbocharger of claim 1 wherein said transmission is a CVT (continuously variable transmission) mechanically coupled to said engine.

13. The driven turbocharger of claim 1 wherein said transmission is an electric motor/generator electrically coupled to said engine.

14. The driven turbocharger of claim 1 wherein said speed reduction drive is a traction drive.

15. The driven turbocharger of claim 5 further comprising:
an intake air bypass tract around said second compressor that supplies intake air to said compressor.

16. The driven turbocharger of claim 1 further comprising:
an EGR (exhaust gas recirculation) pump coupled to said transfer gear.

17. A method of providing boosted airflow to an engine with a driven turbocharger comprising:
connecting a first compressor to a turbo shaft of said driven turbocharger;
connecting a turbine to said turbo shaft of said driven turbocharger;
coupling a speed reduction drive to said turbo shaft that has a low speed output coupled to a transfer gear;
coupling a transmission to said transfer gear that transfers power between said engine and said driven turbocharger;
coupling a second compressor to said transfer gear, wherein said second compressor and said first compressor are arranged in series to provide said boosted airflow to said engine.

18. The method of claim 17 wherein said second compressor is an axial compressor.

19. The method of claim 17 wherein said second compressor is a radial compressor.

20. The method of claim 17 wherein said second compressor is a positive displacement compressor.

21. The method of claim 17 further comprising:
providing a clutch located between said transfer gear and said second compressor.

22. The method of claim 17 further comprising:
providing a speed step up transmission between said transfer gear and said second compressor.

23. The method of claim 17 wherein said transmission is a CVT (continuously variable transmission) mechanically coupled to said engine.

24. The method of claim 17 wherein said transmission is an electric motor/generator electrically coupled to said engine.

25. The method of claim 17 wherein said speed reduction drive is a traction drive.

26. The method of claim 17 further comprising:
coupling an EGR (exhaust gas recirculation) pump to said transfer gear.
